(19) United States
(12) Patent Application Publication
(10) Pub. No.: US 2026/0260951 A1
(43) Pub. Date: Sep. 3, 2026

(54) Battery Cell Having a Housing and an Electrode Coil Inserted Into the Housing

(71) Applicant: Bayerische Motoren Werke Aktiengesellschaft, Muenchen (DE)

(72) Inventors: Manfred RAPP, Forstinning (DE); Hyunchul ROH, Muenchen (DE); Nina ZENSEN, Pfaffenhofen an der Ilm (DE)

(21) Appl. No.: 18/863,391

(22) PCT Filed: May 2, 2023
(86) PCT No.: PCT/EP2023/061488

§ 371 Date: Nov. 6, 2024

(30) Foreign Application Priority Data
May 25, 2022 (DE) 10 2022 113 185.8

(51) Int. Cl. H01M 10/0587; H01M 4/02; H01M 50/107

(52) U.S. Cl. CPC H01M 10/0587; H01M 50/107; H01M 2004/021

(57) ABSTRACT

A battery cell includes a housing and an electrode coil inserted in the housing, wherein the electrode coil comprises a first electrode layer, a first separator layer, a second electrode layer and a second separator layer. The electrode coil also comprises a first region and a second region. A ratio of active material to non-active material in the first electrode layer is greater in the first region than in the second region. The active material can also comprise an expanding active material. Alternatively or additionally, a ratio of the expanding active material to a remaining active material is greater in the first region than in the second region. Alternatively or additionally, a density of the active material is higher in the first region than in the second region.

### BACKGROUND AND SUMMARY

The present disclosure relates to a battery cell having a housing and an electrode coil inserted into the housing.

An object to be achieved is to reduce mechanical stresses within the battery cell.

This object is achieved by the features of the present disclosure. Advantageous configurations are indicated in the present disclosure.

The present disclosure relates to a battery cell having a housing and an electrode coil inserted into the housing, wherein the electrode coil comprises a first electrode layer, a first separator layer, a second electrode layer and a second separator layer. Moreover, the electrode coil comprises a first region and a second region.

Here and hereinafter, the battery cell is a rechargeable battery, for example. The battery cell is thus, for example, an individual rechargeable storage element for electrical energy.

The battery cell is, in particular, a battery cell of a high-voltage storage device of a vehicle.

The term electrode coil generally denotes a wound-up layer sequence having at least one electrode layer. By way of example, such an electrode coil has a cylindrical shape and may also be referred to as a “jelly-roll”.

The electrode layer extends, for example, along a main extension plane. Lateral directions are oriented parallel to the main extension plane and a vertical direction is oriented perpendicular to the main extension plane. The electrode layer further comprises a main extension direction, for example, which hereinafter may also be referred to as longitudinal direction (“longitudinally directed”).

The electrode layer has a length and a width in lateral directions. The length of the electrode layer runs parallel to the main extension direction and the width of the electrode layer runs transversely, in particular perpendicularly, to the main extension direction. The length is, for example, at least five times greater than the width, in particular at least ten times greater. For example, the electrode layer has a width of at least 40 mm and at most 300 mm, in particular 80 mm.

For use in an electrode coil, for example, a plurality of electrode and separator layers are stacked in a vertical direction to form a layer sequence.

The electrode layer is formed with an active electrode material, for example, or is shaped therefrom. Here and hereinafter, the term “anode” shall refer to a negative electrode and the term “cathode” to a positive electrode of the battery cell.

In particular, the electrode layer is shaped with an active anode material or is formed therefrom. In this case, the electrode layer is an anode layer of the battery cell.

The anode layer comprises, for example, an anode active material comprising. for example, a material from the group consisting of carbon-containing materials, silicon, silicon suboxide, silicon alloys, titanium, titanium oxides and mixtures thereof. In particular, the anode active material is selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, titanium, titanium oxides, lithium and mixtures thereof.

The anode layer is applied to an anode current collector. The anode current collector has, for example, a thickness of at least 3 μm to at most 500 μm. For the anode current collector, without restriction, a material can be used which does not induce any chemical changes in the battery cell and has an electrical conductivity. For example, copper, high-grade steel, aluminum, nickel, titanium, calcined carbon, a surface-treated material composed of copper or high-grade steel with carbon, nickel, titanium, silver, an aluminum-cadmium alloy and or similar materials can be used. An adhesive strength of the anode active material can be increased by forming an embossing on one or both of the main surfaces of the anode current collector. The anode current collector is present, for example, in the form of a film, a sheet, a foil, a net, a porous material, a foamed material, a nonwoven material or similar materials.

In particular, the first electrode layer is an anode layer.

Alternatively, the electrode layer is shaped with an active cathode material or is formed therefrom. In this case, the electrode layer is a cathode layer of the battery cell.

The cathode layer comprises a cathode active material, for example. The cathode active material can comprise a multiplicity of particles bound in an electrode binder. The cathode active material can comprise a layered oxide such as, for example, a lithium nickel manganese cobalt oxide (NMC), a lithium nickel cobalt aluminum oxide (NCA), a lithium cobalt oxide (LCO) or a lithium nickel cobalt oxide (LNCO). The layered oxide can be, in particular, an overlithiated layered oxide (OLO). Other suitable cathode active materials are compounds with spinel structure such as, e.g., lithium manganese oxide (LMO) or lithium manganese nickel oxide (LMNO), or compounds with olivine structure such as, e.g., lithium iron phosphate (LFP, LiFePO4) or lithium manganese iron phosphate (LMFP).

The cathode layer is applied to a cathode current collector. The cathode current collector has, for example, a thickness of at least 3 μm to at most 500 μm. For the cathode current collector, without restriction, a material can be used which does not induce any chemical changes in the battery cell and has a high conductivity. For example, stainless steel, aluminum, nickel, titanium, encapsulated carbon, a surface-treated material composed of aluminum or stainless steel with carbon, nickel, titanium, silver or similar materials can be used. As in the case of the anode current collector, in the case of the cathode current collector, too, an adhesive strength of the cathode active material can be increased by forming an embossing on one or both of the main surfaces of the cathode current collector. The cathode current collector is present, for example, in the form of a film, a sheet, a foil, a net, a porous material, a foamed material, a nonwoven material or similar materials.

In particular, the second electrode layer is a cathode layer.

The first separator layer and/or the second separator layer are/is formed with an electrically insulating or electrically nonconductive material, for example, or are/is shaped therefrom. The first separator layer and/or the second separator layer comprise(s) a material which is permeable to lithium ions but impermeable to electrons. As the first separator layer and/or the second separator layer, it is possible to use polymers, in particular a polymer selected from the group consisting of polyesters, in particular polyethylene terephthalate, polyolefins, in particular polyethylene and/or polypropylene, polyacrylonitriles, polyvinylidene fluoride, polyvinylidene-hexafluoropropylene, polyetherimide, polyimide, aramid, polyether, polyether ketone, synthetic spider silk or mixtures thereof. The first separator layer and/or the second separator layer can optionally additionally be coated with ceramic material and a binder, for example, based on Al2O3.

For the first separator layer and/or the second separator layer, it is possible to use, for example, an insulating thin-film layer having high ion permeability and mechanical strength. A pore diameter of the first separator layer and/or the second separator layer is for example at least 0.01 μm and at most 10 μm. The first separator layer and/or the second separator layer have/has a thickness of at least 5 μm and at most 300 μm. For the first separator layer and/or the second separator layer, it is possible to use, for example, an olefin-based polymer, such as chemical-resistant and hydrophobic polypropylene or the like, a sheet or a nonwoven produced using glass fibers, polyethylene or the like. If a solid electrolyte, such as, e.g., a polymer, is used as electrolyte, the solid electrolyte can also function as first separator layer and/or second separator layer. By way of example, it is possible to use a polyethylene film, a polypropylene film or a multilayered film obtained by combination of the films, or a polymer film for a polymer electrolyte or a gel-type polymer electrolyte, such as polyvinylidene fluoride, polyethylene oxide, polyacrylonitrile or polyvinylidene fluoride-hexafluoropropylene copolymer.

In one advantageous configuration of the present disclosure, a ratio of active material to non-active material of the first electrode layer is greater in the first region than in the second region. Moreover, the active material can comprise an expanding active material. Alternatively or additionally, a ratio of the expanding active material to a remaining active material is greater in the first region than in the second region. Alternatively or additionally, a density of the active material is higher in the first region than in the second region.

The expanding active material comprises, in particular, silicon, silicon suboxide, silicon alloys, titanium, titanium oxides and mixtures thereof.

The chemically active substances responsible for energy storage in batteries are referred to as active materials. The non-active materials include, for example, binders, which function as a kind of adhesive and hold the active material together, additives for the active material such as conductivity additives for increasing the electrical conductivity. The non-active materials further include dispersants or thickeners, for example.

The measures described above make it possible to reduce the mechanical stress in the second region, in relation to the first region, whereby the mechanical stress in the battery cell can be reduced.

In one advantageous configuration of the present disclosure, the ratio of active material to non-active material in the first region is between 93% and 98% and the ratio of active material to non-active material in the second region is between 91% and 96%.

Advantageously, the lower ratio of active material to non-active material in the second region thus makes it possible to reduce the electrode swelling in the second region in comparison with the first region. Advantageously, the mechanical stresses within the battery cell are reduced by virtue of the reduced electrode swelling.

In one advantageous configuration of the present disclosure, the ratio of the expanding active material to a remaining active material is between 5 and 30% in the first region and is between 0 and 10% in the second region.

Advantageously, the lower ratio of expanding active material to a remaining active material in the second region thus makes it possible to reduce the electrode swelling in the second region in comparison with the first region. Advantageously, the mechanical stresses within the battery cell are reduced by virtue of the reduced electrode swelling.

In one advantageous configuration of the present disclosure, the density of the active material in the second region is lower than in the first region, preferably up to 10% lower than in the first region.

Advantageously, the lower density of the active material in the second region thus makes it possible to reduce the electrode swelling in the second region in comparison with the first region. Advantageously, the mechanical stresses within the battery cell are reduced by virtue of the reduced electrode swelling.

In one advantageous configuration of the present disclosure, the electrode coil is wound with greater tensile stress in the first region than in the second region. Advantageously, the mechanical stress within the electrode coil can be distributed by virtue of the changed tensile stress.

In one advantageous configuration of the present disclosure, the tensile stress of the electrode coil in the second region is lower than in the first region, preferably up to 20% lower than in the first region. Advantageously, the mechanical stress resulting from the electrode swelling in the second region is reduced by virtue of the lower tensile stress of the electrode coil in the second region.

In one advantageous configuration of the present disclosure, the first electrode layer has a greater mass per unit area in the first region than in the second region. Advantageously, the mechanical stress within the electrode coil can be distributed by virtue of the different mass per unit area of the first and second regions.

In one advantageous configuration of the present disclosure, the mass per unit area of the first electrode layer in the first region is higher than in the second region, preferably up to 10% higher than in the second region. Advantageously, the mechanical stress resulting from the electrode swelling in the second region is reduced by virtue of the lower mass per unit area of the first electrode layer in the second region.

In one advantageous configuration of the present disclosure, the first region has two sub-regions. The second region is arranged between the two sub-regions of the first region.

By virtue of the fact that the second region is arranged between the two sub-regions of the first region, the second region is also situated in wound form between the two sub-regions of the first region. The first region is thus situated in wound form in the center and in the outer electrode layers of the electrode coil. The second region is thus situated therebetween in the inner electrode layers of the electrode coil.

Exemplary embodiments are explained in greater detail below with reference to the schematic drawings.

### BRIEF DESCRIPTION OF THE DRAWINGS

FIG. 1 shows an electrode coil with a housing of a battery cell;

FIG. 2 shows the pressure distribution within an electrode coil;

FIG. 3 shows components of an electrode coil as a layer sequence and the subdivision thereof into sub-regions; and

FIG. 4 shows various winding states of an electrode coil.

### DETAILED DESCRIPTION OF THE DRAWINGS

Elements having the same structural design or function are identified by the same reference signs throughout the figures.

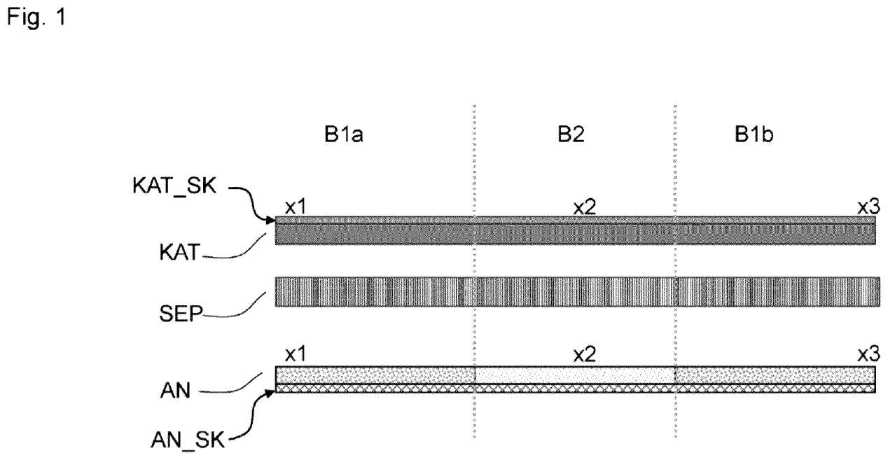

FIG. 1 shows components of an electrode coil 2 as a layer sequence and the subdivision thereof into sub-regions.

In this regard, FIG. 1 shows a positive electrode layer KAT, also called cathode layer KAT, a separator layer SEP and a negative electrode layer AN, also called anode layer AN. The layers are arranged one above another in the order indicated. The cathode layer KAT is applied on a cathode current collector KAT_SK. The anode layer AN is applied on an anode current collector AN_SK. The separator layer SEP insulates the cathode layer KAT and the anode layer AN from one another.

The anode layer AN can also be referred to as first electrode layer. The cathode layer KAT can also be referred to as second electrode layer. The separator layer SEP can also be referred to as first separator layer. In addition, a second separator layer can be provided outside the cathode layer KAT (not shown), which in the wound state likewise insulates the anode layer AN and the cathode layer KAT from one another. FIG. 1 further shows the subdivision of the layer sequence into a first region B1 and a second region B2. The first region B1 is further subdivided into two sub-regions B1a and B1b. The second region B2 is arranged between the two sub-regions B1a and B1b.

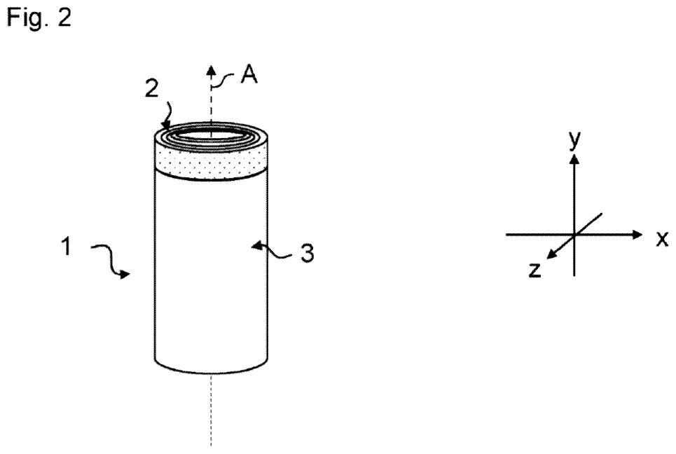

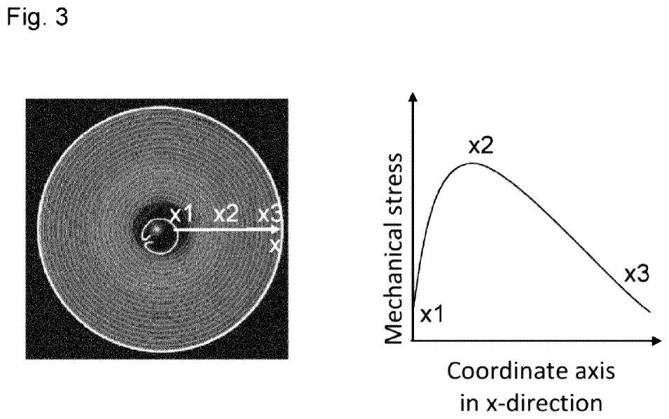

The layer sequence is provided with the reference points x1, x2 and x3. The reference points are explained in greater detail in FIGS. 2 and 3, the reference point x1 lying in the first sub-region B1a, the reference point x2 lying in the second region B2, and the reference point x3 lying in the second sub-region B1b.

FIG. 2 shows an electrode coil 2 with a housing 3 of a battery cell 1. In this case, the layer sequence from FIG. 1 is wound in the longitudinal direction x about the longitudinal axis A to form a cylindrical electrode coil.

FIG. 3 shows a cross-section of the electrode coil 2. The coordinate axis in the x-direction is given in the cross-section for orientation purposes. The reference points x1, x2 and x3 elucidate the positions of the layer sequence from FIG. 1 in the electrode coil. Moreover, FIG. 3 shows a characteristic curve concerning the mechanical stress within the electrode coil 2 along the coordinate axis in the x-direction.

The battery cell 1 can contain an expanding active material, in particular in the anode, such as silicon, silicon suboxide, silicon alloys, titanium, titanium oxides or a mixture or a portion thereof. Mechanical stresses occur within the electrode coil 2 owing to the expanding active material. On account of the design of the battery cell 1, there is room for expansion at the center of the cylindrical battery cell, for example at the reference point x1, and at the inner edge of the housing 3 of the battery, for example at the reference point x3, as a result of which the mechanical stress in this region (first region) turns out to be low. There is no room for expansion between the electrode layers, for example at the reference point x2, as a result of which the mechanical stress in this region (second region) rises.

In order to reduce the mechanical stress within the battery cell 1, the expansion of the active material in the second region B2 is reduced. The exemplary measures relate to the anode of the battery cell.

In order to reduce the expansion, for example, the ratio of active material to non-active material is reduced in the second region B2 in relation to the first region B1.

By way of example, in the first region B1, the anode is composed of 96% by weight active material and 4% by weight non-active material, while in the second region B2, the anode is composed of 93% by weight active material and 7% by weight non-active material.

In order to further reduce the expansion of the active material in the second region, for example, the ratio of the expanding active material to a remaining active material is reduced in the second region B2 in comparison with the first region B1.

By way of example, the anode comprising 96% by weight active material in the first region B1 is composed of a mixture of 30% silicon and 70% carbon. In the second region B2, the ratio of expanding active material (silicon) to the remaining active material (carbon) is reduced by a mixture of 10% silicon and 90% carbon.

The expanding active material can also be silicon suboxide, silicon alloys, titanium or titanium oxides or a combination of the substances mentioned.

In order again to reduce the expansion of the active material in the second region B2, for example, an active material is applied with a lower density in the second region B2 in comparison with the first region B1. The density in the second region B2 is for example 10% lower than in the first region B1.

In order to further reduce the expansion of the active material in the second region B2, for example, an active material is applied with a lower mass per unit area in the second region B2. The mass per unit area of the active material in the first region B1 is for example 10% higher than in the second region B2.

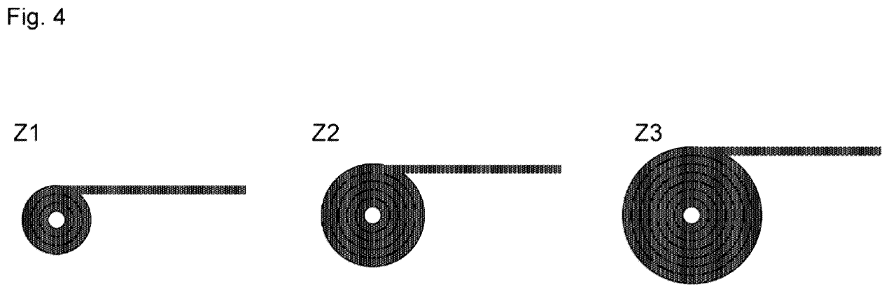

FIG. 4 shows various winding states of the electrode coil 2. In the first winding state Z1, the sub-region B1a from FIG. 1 is wound up. In the second winding state Z2, the second region B2 is wound, and in the third winding state Z3, the sub-region B1b of the layer sequence is wound up to form an electrode coil.

In order to reduce the mechanical stress in the second region B2 of the electrode coil, the electrode coil is wound with a lower tensile stress in the second region B2 than in the first region B1, i.e. in the two sub-regions B1a and B1b. By way of example, the tensile stress in the second region B2 is 20% lower than in the first region B1.

### LIST OF REFERENCE SIGNS

1 battery cell
2 electrode coil
3 housing
A longitudinal axis
AN anode
AN_SK anode current collector
B1 first region
B1a sub-region of the first region
B1b sub-region of the second region
B2 second region
KAT cathode
KAT_SK cathode collector
SEP separator
x1, x2, x3 reference points
x,y,z reference coordinate system
Z1,Z2,Z3 winding states

1-9. (canceled)

10. A battery cell comprising:
a housing; and
an electrode coil inserted into the housing, wherein the electrode coil comprises a first electrode layer, a first separator layer, a second electrode layer and a second separator layer, and wherein the electrode coil comprises a first region and a second region,
wherein:
a ratio of active material to non-active material of the first electrode layer is greater in the first region than in the second region,
the active material comprises an expanding active material, and a ratio of the expanding active material to a remaining active material is greater in the first region than in the second region, and/or
a density of the active material is higher in the first region than in the second region.

11. The battery cell according to claim 10, wherein the ratio of active material to non-active material in the first region of the electrode coil is between 93% and 98% and the ratio of active material to non-active material in the second region of the electrode coil is between 91% and 96%.

12. The battery cell according to claim 10, wherein the ratio of the expanding active material to the remaining active material is between 5 and 30% in the first region of the electrode coil and is between 0 and 10% in the second region of the electrode coil.

13. The battery cell according to claim 10, wherein the density of the active material is lower in the second region of the electrode coil than in the first region of the electrode coil.

14. The battery cell according to claim 10, wherein the first electrode layer has a greater mass per unit area in the first region of the electrode coil than in the second region of the electrode coil.

15. The battery cell according to claim 14, wherein the mass per unit area of the first electrode layer is 0 to 10% higher in the first region of the electrode coil than in the second region of the electrode coil.

16. The battery cell according to claim 10, wherein a tensile stress of the electrode coil is lower in the second region of the electrode coil than in the first region of the electrode coil.

17. The battery cell according to claim 16, wherein the electrode coil is wound with greater tensile stress in the first region of the electrode coil than in the second region of the electrode coil.

18. The battery cell according to claim 10, wherein the first region of the electrode coil has two sub-regions and the second region of the electrode coil is arranged between the two sub-regions.
